(19) United States
(12) Patent Application Publication
(10) Pub. No.: US 2012/0112437 A1
(43) Pub. Date: May 10, 2012

(54) SUSPENSION FOR A VEHICLE

(76) Inventors: Andrè-Marie Simard, Baie St-Paul (CA); Réjean Lavoie, Baie St-Paul (CA)

(21) Appl. No.: 12/942,464

(22) Filed: Nov. 9, 2010

(51) Int. Cl. B60G 5/047; B60G 11/27; B60G 9/02

(52) U.S. Cl. 280/683; 280/124.116

(57) ABSTRACT

A suspension system for a vehicle chassis includes a pair of trailing arms, a pair of air springs and a guiding assembly for preventing lateral loads from being transferred to the air springs. Each trailing arm is pivotally mounted to the vehicle chassis so as to permit an arcuate movement of the vehicle axle. A first lateral surface faces in a first lateral direction and a second lateral surface faces in an opposite second lateral direction. The guiding assembly includes a first guide element mounted beneath the vehicle chassis which extends proximate the first lateral surface so as to block lateral movement thereof in the first lateral direction. The guiding assembly further includes a second guide element mounted beneath the vehicle chassis and which extends proximate the second lateral surface so as to block lateral movement thereof in the second lateral direction. The suspension system can be adapted to a tandem suspension.

### FIELD OF THE INVENTION

The present invention relates to a vehicle suspension.

### BACKGROUND OF THE INVENTION

Suspensions for trucks and the like are well known in the art.

Indeed, a conventional vehicle suspension for connecting a wheeled axle to the structural frame, or chassis, of a vehicle includes a combination of springs and/or shock absorbers mounted beneath the vehicle's chassis so as to absorb, isolate and/or dampen the movements transmitted between the axle and the chassis. Typically, a vehicle such as a truck will include a front axle supporting a pair of front wheels and at least one rear axle supporting a pair of rear wheels. It is also known in the art to provide a second front or rear axle to further increase the load capacity of a truck. Such a dual axle suspension is commonly referred to as a tandem suspension.

Canadian Patent No. 2,070,859, issued Jan. 10, 1995 to Simard and titled “Tandem Axle Suspension for Vehicle”, describes a front suspension for a truck or semi-trailer including front and rear tandem axles connected to a vehicle chassis by leaf springs.

It is also known to use inflatable air springs in conjunction with, or in place of, conventional leaf springs. In particular, it is known that air springs are very effective at absorbing vertical vibration and loads and as such air springs are often used to improve rider comfort. For example, U.S. Pat. No. 6,382,659, issued May 7, 2002 to Simard and titled “Load Distributing Tandem Suspension Assembly”, describes a tandem front suspension similar to that described above, with the addition of an air spring and shock absorber for supporting the second front axle in conjunction with the second leaf spring.

Various disadvantages of air springs are also known. In particular, air springs are weak in shear and, as disposed in conventional vehicle suspensions, are therefore typically not well suited to absorb lateral loads experienced during cornering. Similarly, air springs deployed above an axle in a conventional suspension are not well suited to take moment loads about the axle, as often experienced during braking.

As such, suspensions using air springs as the primary means of support typically require a combination of beams and torque rods in order to take the braking and cornering forces. Examples of such an arrangement are seen in the Hendrickson Parasteer HD (trademark) and Primaax (trademark) front suspensions which employ systems of mechanical linkages to mount air springs beneath the chassis. Both of these suspension systems use laterally extending torque rods to stabilize the assembly and protect the air springs from lateral loads.

It will be appreciated however that torque rods and the like occupy valuable space between and around the frame rails which can conflict with other vehicle components. This problem is most acute for steerable front axles which are proximate transmission, engine and/or steering components.

Similarly, it is known to arrange a combination of air springs and leaf springs so as to protect the former from lateral loads. Examples of such a combination can be found in the U.S. patent mentioned above, as well as in the Kenworth AG130 (trademark) front air suspension which nonetheless includes other lateral members for providing lateral support. However, it would be advantageous to remove the need for leaf springs.

Also known in the art are the following patents and published applications which also describe vehicle suspensions and the like: U.S. Pat. No. 3,063,732, U.S. Pat. No. 3,233,915, U.S. Pat. No. 3,285,621, U.S. Pat. No. 3,762,487, U.S. Pat. No. 3,902,734, U.S. Pat. No. 4,619,467, U.S. Pat. No. 4,676,523, U.S. Pat. No. 4,966,387, U.S. Pat. No. 5,271,638, U.S. Pat. No. 5,354,091, U.S. Pat. No. 5,615,906, U.S. Pat. No. 5,873,581, U.S. Pat. No. 6,224,074, U.S. Pat. No. 6,276,710, U.S. Pat. No. 6,364,340, U.S. Pat. No. 6,460,872, U.S. Pat. No. 6,857,647, US 2005/0263986, and US 2006/0208464.

However, there remains a need for a vehicle suspension which makes better use of the afore-mentioned advantageous features of air springs and is able to provide increased ride comfort for a user.

### SUMMARY OF THE INVENTION

An object of the present invention is to provide a vehicle suspension which, by virtue of its design and components, satisfies some of the above-mentioned needs and is thus an improvement over other related devices and/or suspension systems known in the prior art.

According to a first aspect of the invention, a suspension system for a vehicle chassis is provided which includes a pivoting structure which includes a vehicle axle and a pair of trailing arms, a pair of air springs for absorbing shocks experienced by the vehicle axle and a guiding assembly for preventing lateral loads from being transferred to the air springs. Each trailing arm is pivotally mounted to the vehicle chassis and fixedly mounted to the vehicle axle so as to permit an arcuate movement of the vehicle axle with respect to the vehicle chassis. The pivoting structure has a first lateral surface facing in a first lateral direction and a second lateral surface facing in a second lateral direction, and the second lateral direction is opposite the first lateral direction. Each air spring is fixedly mounted between the vehicle chassis and the vehicle axle along a respective one of the pair of trailing arms. The guiding assembly includes a first guide element mounted beneath the vehicle chassis which extends proximate the first lateral surface so as to block lateral movement thereof in the first lateral direction. The guiding assembly further includes a second guide element mounted beneath the vehicle chassis and which extends proximate the second lateral surface so as to block lateral movement thereof in the second lateral direction.

Preferably, the first lateral surface extends along either one of the trailing arms and the second lateral surface extends along either one of the trailing arms. More preferably, each of the pair of trailing arms includes a respective one of a first upwardly extending projection and a second upwardly extending projection, the first lateral surface extending along a first lateral side of the upwardly extending projection and the second lateral surface extending along a second lateral side of the second upwardly extending projection.

According to another aspect of the present invention, a tandem suspension system for a vehicle chassis is provided which includes a first pivoting structure including a first vehicle axle and a first pair of trailing arms, a second pivoting structure having a second vehicle axle and a second pair of trailing arms, a first pair of air springs for absorbing shocks experienced by the first vehicle axle, a second pair of air springs for absorbing shocks experienced by the second vehicle axle, and a first pivoting structure guiding assembly for preventing lateral loads from being transferred to the first pair of air springs. Each of the first pair of trailing arms is pivotally mounted to the vehicle chassis and fixedly mounted to the first vehicle axle so as to permit an arcuate movement of the first vehicle axle with respect to the vehicle chassis. The first pivoting structure has a first lateral surface facing in a first lateral direction and a second lateral surface facing in a second lateral direction, and the second lateral direction is opposite the first lateral direction. Each of the second pair of trailing arms is pivotally mounted to the vehicle chassis and fixedly mounted to the second vehicle axle so as to permit an arcuate movement of the second vehicle axle with respect to the vehicle chassis. Each of the first pair of air springs is mounted between the vehicle chassis and the first vehicle axle along a respective one of the first pair of trailing arms. Each of the second pair of air springs is mounted between the vehicle chassis and the second vehicle axle along a respective one of the second pair of trailing arms. The first and second pairs of air springs are pneumatically equalised. The first pivoting structure guiding assembly includes a first guide element mounted beneath the vehicle chassis which extends proximate the first lateral surface so as to block lateral movement thereof in the first lateral direction. The first pivoting structure guiding assembly includes a second guide element mounted beneath the vehicle chassis which extends proximate the second lateral surface so as to block lateral movement thereof in the second lateral direction.

Preferably, the vehicle axle is fixedly mounted at a position along each trailing arm which is between the pivotal mounting with the vehicle chassis and the fixed mounting with each air spring.

Preferably, the first lateral surface extends along either one of the trailing arms and the second lateral surface extends along either one of the trailing arms.

The expression “lateral”, as used herein, should be understood as being relative to the frame of reference of the vehicle. The “lateral directions” are therefore perpendicular to the longitudinal axis of the vehicle and its direction of travel (when moving in a straight line), and generally in line with the axle. Moreover, it will be understood that physical components, such as surfaces, guides and the like, as well as the loads experienced by the vehicle suspension, need only have a component facing or aligned in a lateral direction to be considered “lateral”.

As can be appreciated, a vehicle suspension according to the present invention can advantageously improve the absorption, isolation and dampening of axle movement during operation of the vehicle. Specifically, a vehicle suspension according to an embodiment of present invention may enable the incorporation of air springs into vehicles where they would otherwise not fit due the reliance of conventional air spring suspensions on torque rods and other lateral members to provide lateral support.

In addition, it will be appreciated that a vehicle suspension according to the present invention may be more compact and therefore easier to package beneath a vehicle chassis. In particular, a vehicle suspension according to the present invention may be used without laterally extending torque rods, beams or the like.

It will also be appreciated that a vehicle suspension according to the present invention may be easier to install as a retrofit improvement to a conventional leaf spring suspension assembly.

The invention and its advantages will be better understood by reading the following non-restrictive description of a preferred embodiment thereof, made with reference to the accompanying drawings.

### BRIEF DESCRIPTION OF THE DRAWINGS

FIG. 1 is a perspective view of a vehicle suspension in accordance with an embodiment of the present invention.

FIGS. 2 and 3 are side views of the suspension of FIG. 1, the latter including a section of the vehicle chassis.

FIG. 4 is an exploded view of the suspension of FIG. 1.

FIG. 5 is a perspective view of a tandem suspension in accordance with another embodiment of the present invention.

FIG. 6 is a side view of the tandem suspension of FIG. 5, shown attached to the vehicle chassis.

FIG. 7 is a top view of a tandem suspension according to yet another embodiment of the present invention.

FIGS. 8A and 8B are two perspective views of a preferred embodiment of a bracket incorporating first and second guide elements.

### DETAILED DESCRIPTION OF PREFERRED EMBODIMENTS OF THE INVENTION

In the following description, the same numerical references refer to similar elements. The embodiments shown in the figures are preferred, for exemplification purposes only.

In addition, although the preferred embodiments of the present invention as illustrated in the accompanying drawings includes various components, etc., and although the preferred embodiments of the suspension and corresponding parts of the present invention as shown consist of certain geometrical configurations as explained and illustrated herein, not all of these components and geometries are essential to the invention and thus should not be taken in their restrictive sense, i.e. these components and geometries should not be taken as to limit the scope of the present invention. It is to be understood, as also apparent to a person skilled in the art, that other suitable components and cooperations therebetween, as well as other suitable geometrical configurations may be used for the suspension according to the present invention, as will be briefly explained herein and as can be easily inferred herefrom by a person skilled in the art, without departing from the scope of the invention.

It will be appreciated that positional descriptions such as “front”, “rear” and the like should, unless otherwise indicated, be taken in the context of the figures and should not be considered limiting.

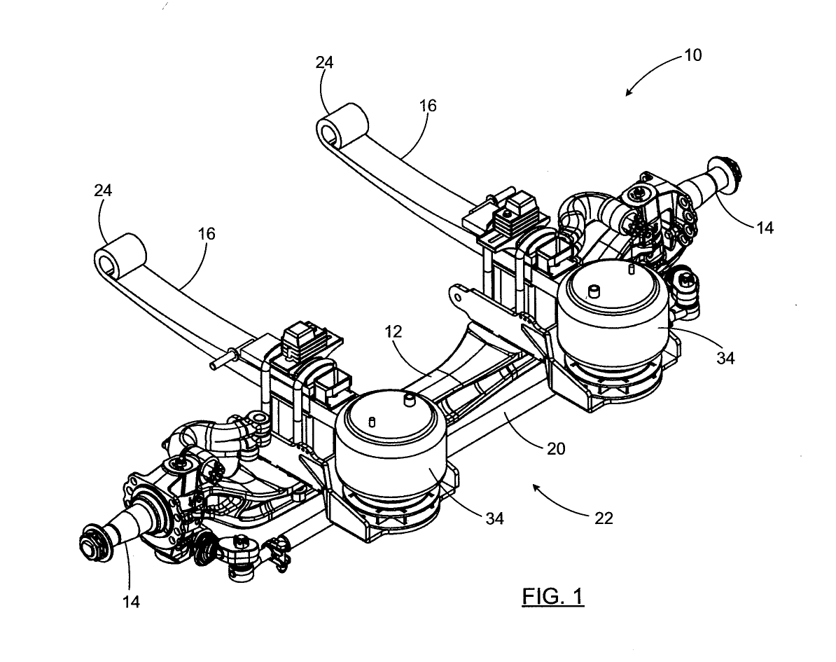

With reference to FIGS. 1 to 3, a suspension system 10 for a vehicle chassis 18 according to one embodiment of the invention is shown. The suspension system includes a pivoting structure formed by a vehicle axle 12 and a pair of trailing arms 16. The axle 12 includes a spindle 14 at either extremity to which wheels (not shown) are mounted, as is known in the art. The axle 12 of the illustrated embodiment is a steered axle having a steering linkage 20, although it will be appreciated that other types of axles, such as non-steered axles or drive/steer axles, may similarly be mounted to the chassis 18 within a suspension system 10 in accordance with the present invention.

The trailing arms 16 are elongate members which are pivotally mounted to the chassis 18 at one end so as to extend rearwards therefrom. Each trailing arm 16 is further fixedly mounted to the vehicle axle 12; in this manner, an arcuate movement of the vehicle axle 12 with respect to the chassis 18 is permitted. In fact, in the illustrated embodiment the entire pivoting structure, formed by the axle 12 and the trailing arms 16 together, follows an arcuate movement 30 about an axis 32 below the chassis 18.

As will be appreciated, the pivotal mounting of the trailing arms 16 to the chassis 18 can be embodied in a number of different ways, including by providing an eye 24 at the extremity of each leaf spring 16, which is connected to a bracket 28 by a pin 26. Preferably, the eyes 24 are sized and shaped like the eyes commonly found at the extremities of conventional leaf springs. As such, when installing the suspension 10 on an existing vehicle having a conventional leaf spring suspension, the trailing arms 16 can be installed in the original brackets 28.

Preferably, each trailing arm 16 is unitary in construction and extends between the chassis 18 and the axle 12 as a solid, elongate member rather than a multi-piece construction having two or more articulating sections such as 4-bar mechanism or the like. However, it will be appreciated that a trailing arm 16 constructed from a plurality of rigidly connected pieces would provide the same arcuate movement 30 as the illustrated embodiment and should therefore be understood to constitute a preferred “unitary” construction.

The suspension system 10 further includes a pair of air springs 34, each one associated with one of the trailing arms 16. Each air spring 34 is disposed between the vehicle axle 12 and the chassis 18 so as to prevent or at least minimise shocks passed between the two. It will be appreciated however that this does not mean that the air springs 34 be attached directly to the axle 12, rather the air springs 34 can be attached to any suitable component which pivots with the axle 12 beneath the chassis 18. Preferably, each air spring 34 is positioned along a respective one of the trailing arms 16. Air springs typically have a substantially cylindrical form with flat top and bottom faces. The hollow, resilient bodies of the air springs 34 are operable to expand and contract vertically so as to, inter alia, absorb vertical shocks experienced by the axle 12, as will be appreciated by one of ordinary skill in the art and will not be discussed in further detail herein.

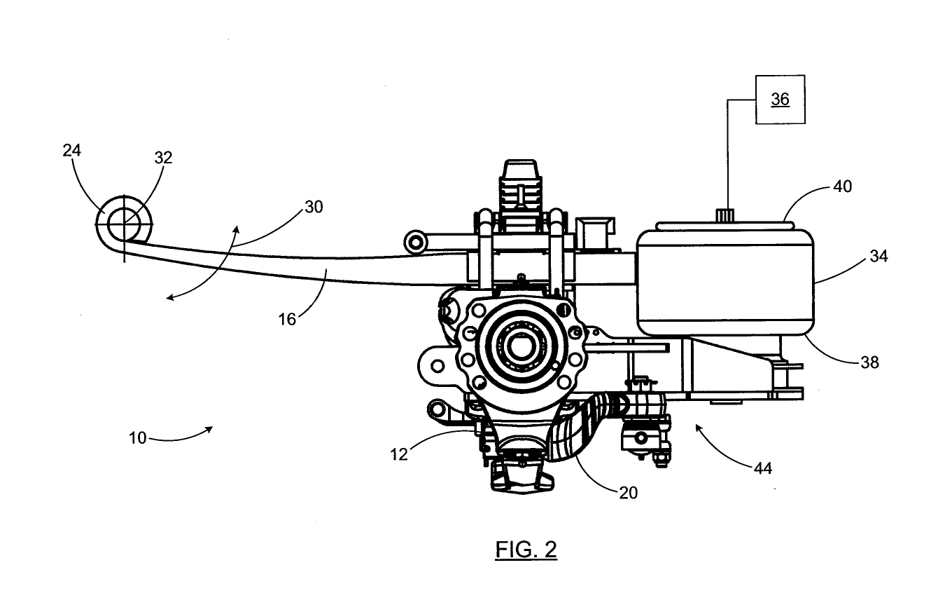

The air springs 34 are connected to a pneumatic system 36, shown schematically in FIG. 2, which includes a tank for supplying pressurized air to the springs 34, as well as means for controlling the air pressure therein. The use and control of these elements is known in the art and will not be discussed further herein.

The bottom face 38 of each air spring 34 is fixed to a respective trailing arm 16 and its top face 40 is fixed to the chassis 18. Preferably, each trailing arm 16 comprises a beam portion 42 having the eye 24 at one end, and an air spring seat 44 which is attached at the opposite end of the beam portion 42 and which receives the bottom face 38.

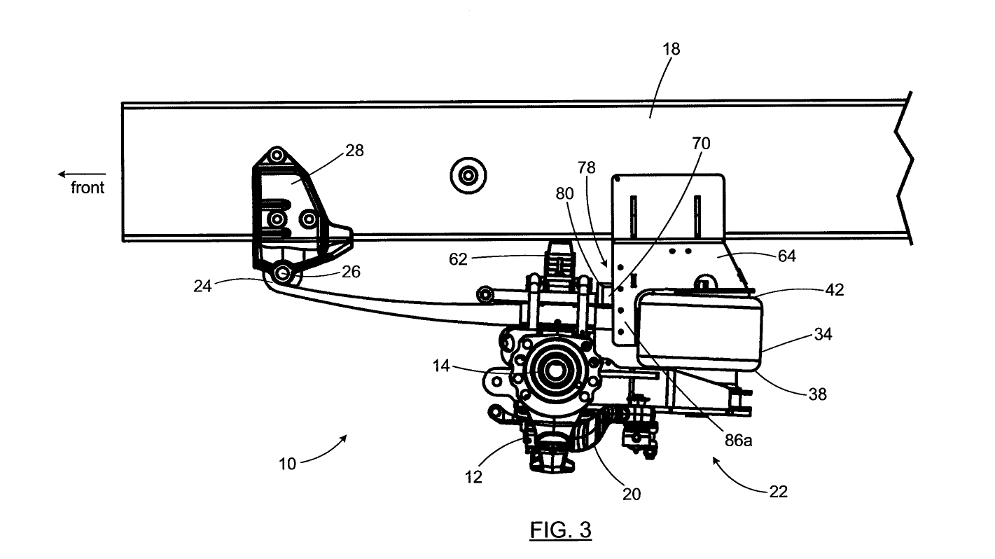

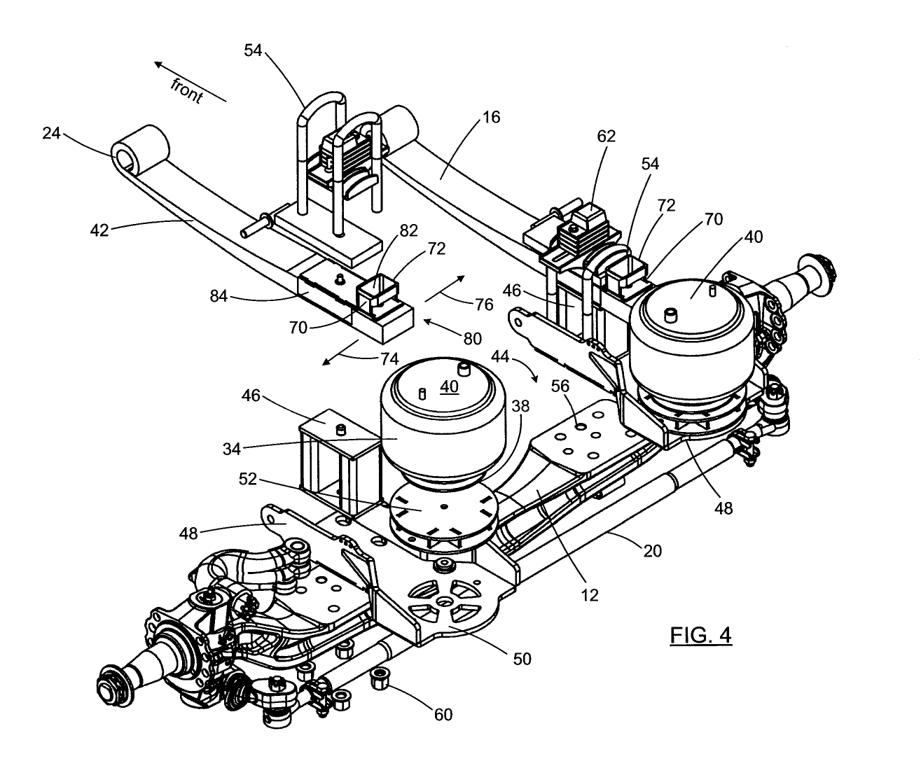

With additional reference to FIG. 4, the spring seats 42 are preferably constructed so as to lower of the air springs 34 with respect to the remainder of the trailing arms 18. Each spring seat 44 comprises a spacing block 46 which is connected to the underside of the beam portion 42 and extends downwards therefrom, and a support plate 48 attached to the underside of the spacing block 46 which provides a receiving area 50 sized and shaped to receive the bottom face 38. If necessary, a spacing plate 52 may be positioned between the bottom face 38 and the support plate 48 in accordance with the dimensions of the specific air spring 34. As will be appreciated by one skilled in the art, the size of the spacing plate 52 can affect the ride height and travel of the suspension 10, while the size of the block 46 can affect the caster angle of the axle 12. As seen in FIG. 3, the top face 40 of each air spring fixed to the chassis via a respective bracket 64.

In the embodiment illustrated, and as seen most readily in the side views of FIGS. 2 and 3, the axle 12 is attached to the trailing arms 16 at a position between the air springs 34 and the eyes 24. In this arrangement the distance between the pivoting axis 32 and the air springs 34 is greater than the distance between the pivoting axis 32 and the axle 12. Accordingly, the air springs 34 (or more precisely their bottom faces 38) will experience a greater displacement than the axle 12 as the latter moves with respect to the chassis 18. In contrast to a conventional suspension system which positions its air springs directly over the axle, this use of mechanical advantage, or leverage, advantageously increases the degree to which the air springs 34 can absorb shocks experienced by the axle 12 and allows for the use of smaller air springs. In addition, this arrangement can allow for a more convenient packaging of the components of the suspension system 10. It will be appreciated however that the precise positions and distances of these elements may be varied in accordance with the specific geometry and/or arrangement of the suspension system 10.

In the illustrated non-limitative embodiment of FIGS. 1 to 4, the axle 12 and trailing arms 16 are fixedly attached by a pair of U-bolts 54 which extend over the trailing arms 16 and through a corresponding set of bolt holes 56 within a flattened area 58 formed along the axle 12. As is known in the art, nuts 60 can then be used to retain the threaded extremities of the U-bolts 54, which extend beneath the axle 12. Preferably, the beam portion 42, the spacing block 46 and a portion of the support plate 48 opposite the receiving area 50 are all aligned above the axle 12 and are bound thereto by the U-bolts 54. An axle stopper 62 is also preferably attached above the axle 12, and retained by the U-bolts 54, so as to limit the upward range of motion of the axle 12 and limit the maximum deflection of the air springs 34. As seen in FIG. 3, when the axle stopper 62 reaches the underside of the chassis 18, the axle 12 cannot rise any further.

The pivoting structure 22 further includes at least one set of first and second lateral surfaces 70 and 72 which face in opposed first and second lateral directions 74 and 76. As will be discussed in further detail below, the suspension system 10 further includes a guiding assembly 78 which interact with the first and second lateral surfaces 70 and 72 so as to block lateral movement of the axle 12 with respect to the chassis 18 and prevent lateral loads imparted to the axle 12 from being transferred to the air springs 34 in a potentially damaging manner.

Preferably, the lateral surfaces 70 and 72 are formed by upwardly extending projections 80 which are present on one or both trailing arms 16. As seen most clearly in FIG. 4, the illustrated embodiment of the suspension system 10 includes two projections 80 which extend upwards from respective ones of the beam portions 42. These projections 80 have a rectangular hollow body 82 which forms the first and second lateral surfaces 70 and 72 on either lateral side thereof. Specifically, the first lateral surface 70 is formed along the left side of the body 82 which faces in the first lateral direction 74, while the second lateral surface 72 is formed along the right side of the body 82 which faces in the second lateral direction 76. The upwardly extending projection 80 further includes a base portion 84 which extends along the beam portion 42 of the respective trailing arm 16 so as to be sandwiched by the U-bolts 54 along with the axle stopper 62, the spacing block 46 and the support plate 48.

As mentioned above, the suspension system 10 further includes the pivoting structure guiding assembly 78, referred hereinafter as the “guiding assembly” for simplicity. The guiding assembly 78 includes a pair of guide elements 86a and 86b which are fixed to the chassis 18 and extend alongside respective ones of the first and second lateral surfaces 70 and 72. As seen in FIG. 3 which shows only the first guide element 86a, the bracket 64 which attaches the top face 40 of the air spring 34 to the chassis 18 can be combined with the downwardly extending guide element 86a which is positioned next to the first (left) lateral side 70 of the partially-hidden projection 80. It will be appreciated however that the guide element 86a need not be combined with the bracket 64 in this manner. Indeed, the projection 80 could be placed elsewhere along the trailing arm 16, or the lateral surfaces 70 and 72 could be placed elsewhere along the pivoting structure 22 and the guiding assembly 78 positioned accordingly.

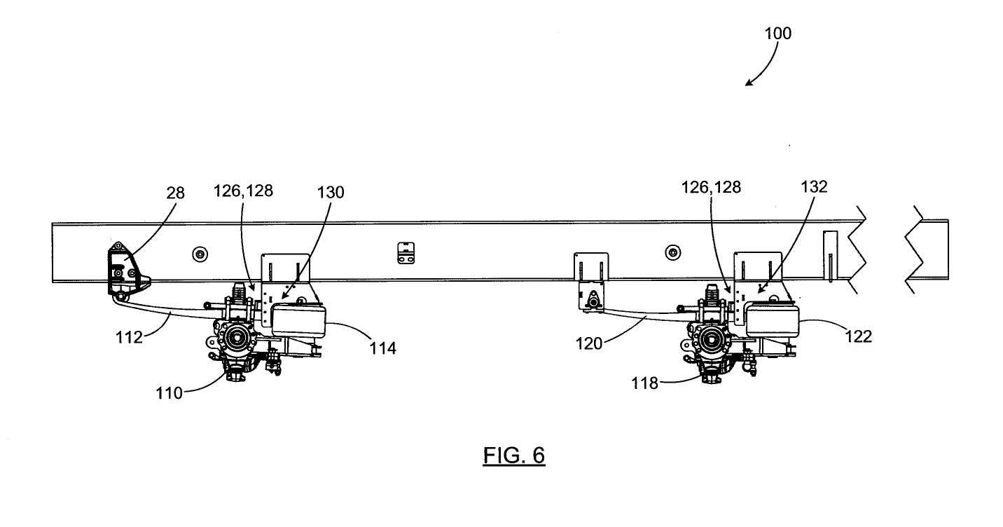

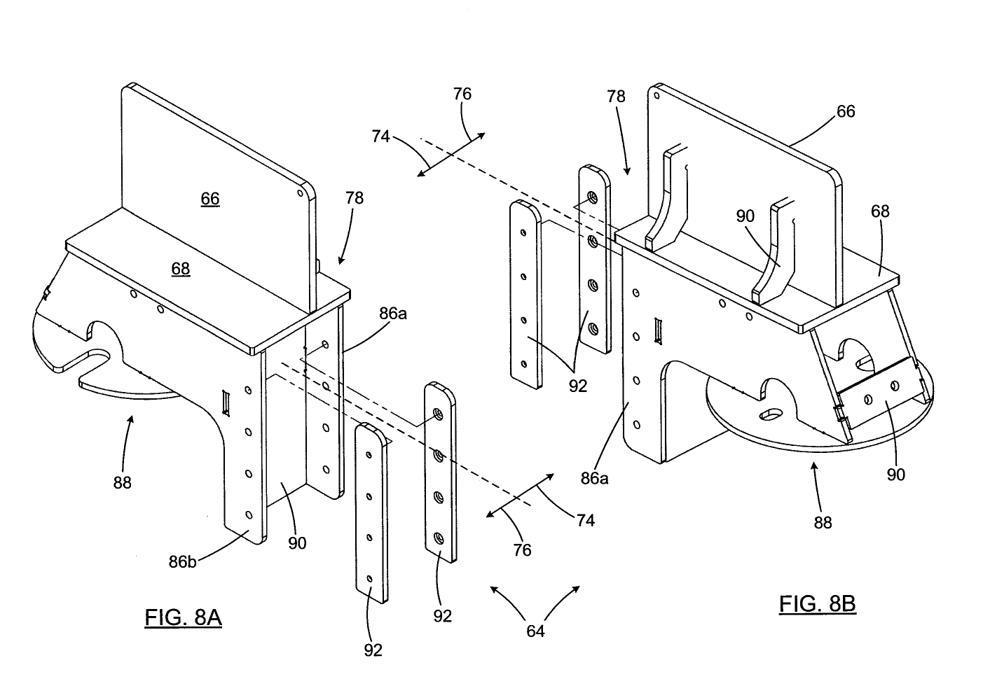

With reference to FIGS. 8A and 8B, a preferred embodiment of a bracket 64 incorporating a first guide element 86a and a second guide element 86b is shown. The bracket 64 includes a vertical panel 66 and a horizontal panel 68 which are attached (alongside and underneath, respectively) to the chassis 18 as seen in FIGS. 3 and 6. Below the panels 66 and 68, the bracket 64 forms another receiving area 88 which is sized and shaped to receive the top face 40 of the respective air spring 34.

When the lateral surfaces 70 and 72 of the pivoting structure 22 are located near the air springs 34, it can be convenient to combine the air springs bracket 64 and the guiding assembly 78 in a single structure. As shown in the illustrated embodiment, the first and second guide elements 86a and 86b are elongate plates which extend below the horizontal panel 68, parallel to the vertical panel 66. It will be appreciated however that various other embodiments of both the bracket guiding assembly are well within the scope of the present invention.

The brackets 64 and guiding assembly 78 are preferably formed from sections of sheet metal, which can be cut, bent, welded or otherwise worked so as to form the above-described structure. As such, the brackets 64 and guiding assembly 78 can be provided with reinforcing members 90 which strengthen and solidify the structure. It will be apparent, however, to one of ordinary skill in the art that various other materials and construction techniques could similarly be used in accordance with other embodiments of the present invention.

In use, the guide elements 86a and 86b are positioned sufficiently close to their respective lateral sides 70 and 72 and built sufficiently robustly to counteract any lateral movement experienced by the pivoting structure 22 which might be damaging to the air springs 34. The guide elements 86a and 86b should preferably not be so close to the lateral sides 70 and 72 that they unduly impede or otherwise negatively effect the arcuate movement 30 of the pivoting structure 22. It will be appreciated however that the air springs 34 may tolerate a certain amount of lateral play. It will also be appreciated that the guide elements 86a and 86b can be provided with inserts 92 such as the shims shown in FIGS. 8A and 8B, which can be installed between the lateral surfaces 70 and 72 and the guide elements 86a and 86b. In the illustrated embodiment, these shims 92 are fixed to the guide elements 86a and 86b although they could also be fixed along the first and second lateral surfaces 70 and 72. Such inserts 92 could be bushings selected from a material which reduces friction between each lateral surface 70 or 72 and the adjacent guide elements 86a and 86b and also serve as wear parts.

When assembled, the upwardly extending projection 80 will fit between the guide elements 86a and 86b such that the first lateral surface 70 faces the first guide element 86a and the second lateral surface 72 faces the second guide element 86b. The guide element 86a visible in FIG. 3 is positioned across from the first lateral surface 70, which is to say leftwards in the frame of reference of the vehicle. Accordingly, the presence of the first guide element 86a therefore prevents displacement of the projection 80, and hence the pivoting structure 22 of which it is rigidly a part, in the first lateral direction. Similarly, the second guide element 86b will block movement of the upwardly extending projection 80, and hence the whole pivoting structure 22, in the second lateral direction 86.

It will be appreciated therefore that various combinations of lateral surfaces 70 and 72 and guide elements 86a and 86b can be used according to the specific constraints of the suspension system 10 and/or the vehicle. The first and second lateral surfaces 70 and 72 can both be provided along either one of the left side or right side trailing arms 16, in which case the guiding assembly 78 is mounted on just one side of the suspension system 10. Alternatively, the first lateral surface 70 and the second lateral surface 72 can be provided on separate trailing arms 16. When only one of each projection 80's lateral surfaces 70 and 72 is provided, or when only one is utilised, the guide elements 86a and 86b will be provided either outside the pair of trailing arms 16, that is to say to the left of the left trailing arm 16 and to the right of the right trailing arm 16, or between the two trailing arms 16, that is to say to the right of the left trailing arm 16 and to the left of the right trailing arm 16.

While only two oppositely facing lateral surfaces 70 and 72 are required, all four are preferably utilized by providing pairs of guide elements 86a and 86b on both sides of each projection 80. In the case of the illustrated embodiment, that means each of the two brackets 64 would include first and second downwardly extending guide elements 86a and 86b so as to doubly block lateral movement. In this doubly blocking embodiment, the upwardly extending projections 80 can be considered male members which fit between the female pairs of first and second downwardly extending guide elements 86a and 86b.

Preferably and as illustrated, both the lateral surfaces 70 and 72 and their respective guide elements 86a and 86b are flat and parallel to one another, facing only in one of the two lateral directions 74 or 76. However, as noted above, the lateral surfaces 70 and 72 need only have a component or portion thereof which is facing one of the lateral directions 74 and 76 in order to engage the guide elements 86a and 86b positioned therebeside when the axle is pushed laterally. As such, the lateral surfaces 70 and 72 may be angled with respect to the lateral directions 74 and 76 and/or may be curved. Similarly, the guide elements 86a and 86b need not be flat or perfectly aligned with the surfaces 70 and 72. Rather, they must merely be positioned to block undesired lateral movement of the pivoting structure 22.

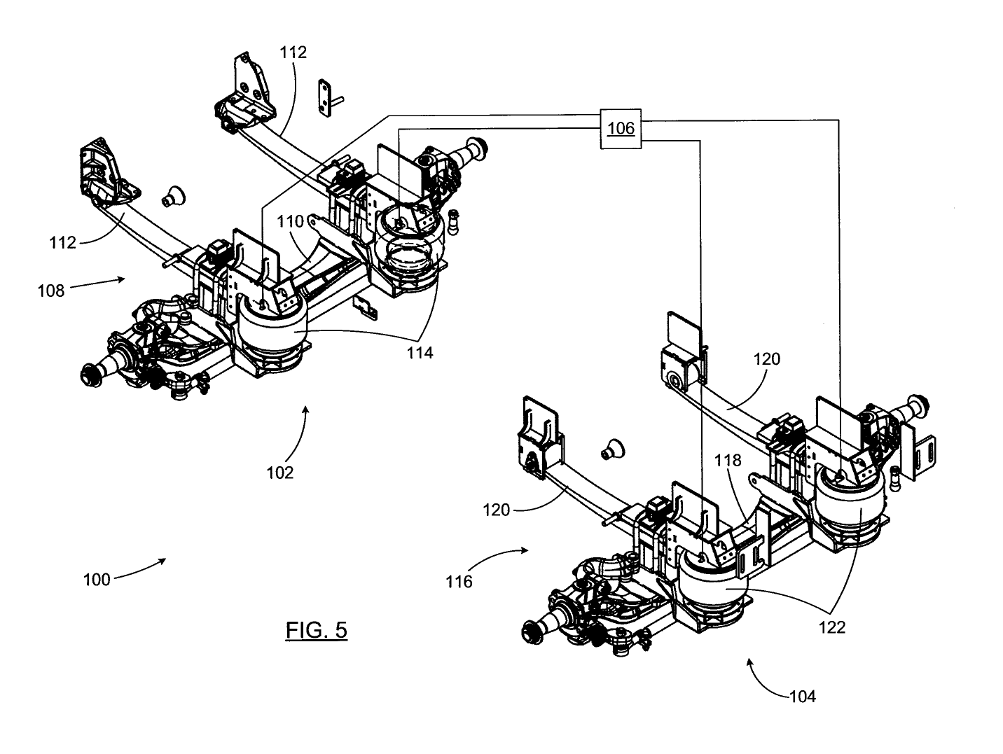

The suspension system 10 can be used to support a single axle 12, as shown in FIGS. 1 to 4, or in combination as part of a tandem suspension. With reference now to FIGS. 5, 6 and 7, a tandem suspension 100 is shown which includes two single axle suspensions 102 and 104 that are equalized pneumatically by a pneumatic system 106. The first single axle suspension 102, here at the front of the tandem suspension 100, includes a first pivoting structure 108 which is made up of a first axle 110 and a first pair of trailing arms 112, as per the previously described suspension system 10. The first suspension 102 further includes a first pair of air springs 114.

The front suspension system 102 can be coupled to various types of air spring suspensions in order to form a tandem suspension 100. Preferably however, the rear single axle suspension 104 similarly comprises a rear pivoting structure 116 which is made up of a rear axle 118 and a pair of rear trailing arms 120, as well as a pair of rear air springs 122, as per the previously described suspension system 10. The front and rear air springs 122 are pneumatically balanced by the pneumatic system 106 and this balancing enables loads taken by one of the front air springs 114 to be shared with the corresponding rear air spring 122. It is less common, although certainly possible, to balance loads between the left and right side air springs 114 or 122 since this may affect the operation of the tandem suspension 100 during braking and cornering.

This rear pivoting structure 116 will comprise third and fourth lateral surfaces 126 and 128 which are equivalent to the first and second lateral surfaces 126 and 128 referred to above. Similarly, the third and fourth lateral 140 and 142 face in the first and second lateral directions 74 and 76, respectively.

It is not uncommon to upgrade a vehicle by replacing an existing single axle leaf spring suspension with a tandem suspension, such as the tandem suspension 100, in order to improve its ride comfort. As mentioned above, the present invention can be advantageously applied to such a retrofit since the front trailing arm 112 can be pivotally attached to the chassis 18 via the original leaf spring bracket 28 (FIG. 6).

As described above in relation to the illustrated embodiment of the suspension system 10, the tandem suspension 100 is preferably provided with lateral surfaces 126 and 128 along portions of each of the front and rear trailing arms 112 and 120. The tandem suspension 100 further includes a front guiding assembly 130 having first and second guide elements 136a and 136b which interact with the first and second surfaces 126 and 128, as well as a rear guiding assembly 132 having third and fourth guide elements 144 and 146 which interact with the third and forth lateral surfaces 140 and 142.

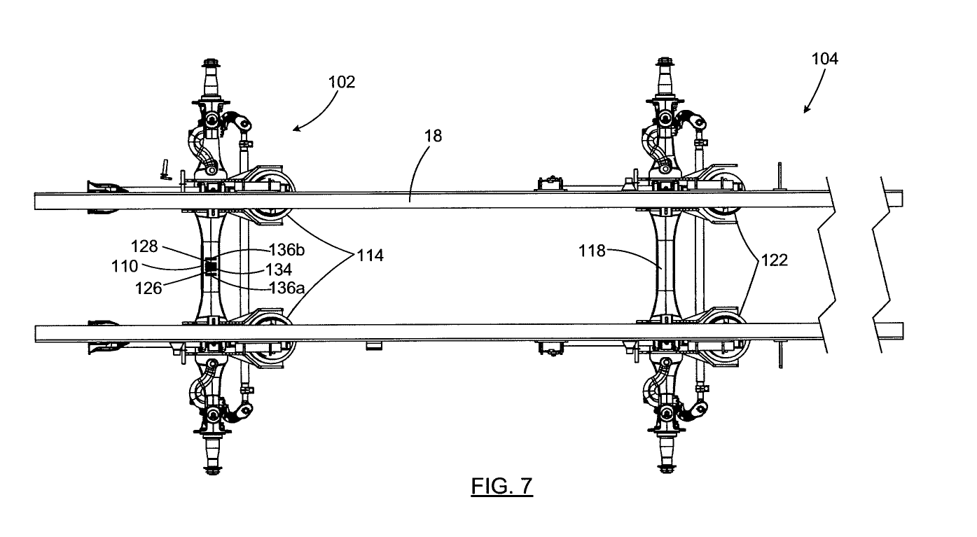

Alternatively, and as shown schematically in FIG. 7, the first and second lateral surfaces 126 and 128 could be provided along one of the axles 114 or 118 instead of one or both of the trailing arms. In this alternate embodiment, the axle 110 is provided with an upwardly extending projection 134 which forms the first and second lateral surfaces 126 and 128, and the corresponding first and second guide elements 136a and 136b are mounted proximate thereto. It will be appreciated that providing the lateral surfaces 126 and 128 on this part of the pivoting structures 108 and/or 116 will similarly prevent lateral loads from being transmitted to the air springs 114 and/or 122.

Advantageously, the above suspension systems 10 and 100 could be applied to tridem or other multi-axle systems, both steered and un-steered, by further linking and balancing the air springs. As such, the need for a mechanical balancing system such as an equaliser bar and the like is avoided.

As being now better appreciated, the present invention is an improvement and presents several advantages over other related devices and/or methods known in the prior art. Indeed, embodiments of the present invention are particularly advantageous in that they avoid the need for laterally extending torque rods and the like, thereby easing packaging of the suspension below the chassis. In addition, it will be appreciated that a suspension in accordance with the present invention can be conveniently installed in place of a conventional single axle leaf spring suspension system as part of a retrofit process.

Of course, numerous modifications could be made to the above-described embodiments without departing from the scope of the invention, as apparent to a person skilled in the art. While a specific embodiment of the present invention has been described and illustrated, it will be apparent to those skilled in the art that numerous modifications and variations can be made without departing from the scope of the invention as defined in the appended claims.

1. A suspension system for a vehicle chassis, the suspension system comprising:
a) a pivoting structure comprising:
i) a vehicle axle; and
ii) a pair of trailing arms, each trailing arm being pivotally mounted to the vehicle chassis and fixedly mounted to the vehicle axle so as to permit an arcuate movement of the vehicle axle with respect to the vehicle chassis;
the pivoting structure having a first lateral surface facing in a first lateral direction and a second lateral surface facing in a second lateral direction, the second lateral direction being opposite the first lateral direction;
b) a pair of air springs for absorbing shocks experienced by the vehicle axle, each air spring fixedly mounted to a respective one of the pair of trailing arms between the vehicle chassis and the vehicle axle; and
c) a guiding assembly for preventing lateral loads from being transferred to the air springs, the guiding assembly comprising:
i) a first guide element mounted beneath the vehicle chassis and extending proximate the first lateral surface so as to block lateral movement thereof in the first lateral direction;
ii) a second guide element mounted beneath the vehicle chassis and extending proximate the second lateral surface so as to block lateral movement thereof in the second lateral direction.

2. The suspension system of claim 1, wherein the vehicle axle is fixedly mounted at a position along each trailing arm which is between the pivotal mounting of the trailing arm to the vehicle chassis and the fixed mounting of the trailing arm to the corresponding air spring.

3. The suspension system of claim 1, wherein the first lateral surface extends along either one of the trailing arms and the second lateral surface extends along either one of the trailing arms.

4. The suspension system of claim 3, wherein the either one of the trailing arms comprises an upwardly extending projection, the first lateral surface extending along a first lateral side of the upwardly extending projection.

5. The suspension system of claim 4, wherein the second lateral surface extends along a second lateral side of the upwardly extending projection.

6. The suspension system of claim 4, wherein the upwardly extending projection is located along the respective one of the trailing arms between the fixed mounting of the respective trailing arm to the axle and the fixed mounting of the respective trailing arm to the respective air spring.

7. The suspension system of claim 4, wherein the upwardly extending projection comprises a rectangular hollow body.

8. The suspension system of claim 3, wherein each of the pair of trailing arms comprises a respective one of a first upwardly extending projection and a second upwardly extending projection, the first lateral surface extending along a first lateral side of the upwardly extending projection and the second lateral surface extending along a second lateral side of the second upwardly extending projection.

9. The suspension system of claim 1, wherein the trailing arms each have a unitary construction.

10. The suspension system of claim 1, wherein each of the trailing arms comprises an air spring seat opposite the pivotal mounting with the vehicle chassis to which the respective air spring is fixedly mounted.

11. The suspension system of claim 10, wherein each air spring seat receives the respective air spring at a position below the remainder of the respective trailing arm.

12. The suspension system of claim 1, wherein the axle comprises an upwardly extending projection, the first lateral surface extending along a first lateral side of the upwardly extending projection.

13. A tandem suspension system for a vehicle chassis, the suspension system comprising:
a) a first pivoting structure comprising:
i) a first vehicle axle; and
ii) a first pair of trailing arms, each of the first pair of trailing arms being pivotally mounted to the vehicle chassis and fixedly mounted to the first vehicle axle so as to permit an arcuate movement of the first vehicle axle with respect to the vehicle chassis;
the first pivoting structure having a first lateral surface facing in a first lateral direction and a second lateral surface facing in a second lateral direction, the second lateral direction being opposite the first lateral direction;
b) a second pivoting structure comprising:
i) a second vehicle axle; and
ii) a second pair of trailing arms, each of the second pair of trailing arms being pivotally mounted to the vehicle chassis and fixedly mounted to the second vehicle axle so as to permit an arcuate movement of the second vehicle axle with respect to the vehicle chassis;
c) a first pair of air springs for absorbing shocks experienced by the first vehicle axle, each of the first pair of air springs mounted to a respective one of the first pair of trailing arms between the vehicle chassis and the first vehicle axle;
d) a second pair of air springs for absorbing shocks experienced by the second vehicle axle, each of the second pair of air springs mounted to a respective one of the second pair of trailing arms between the vehicle chassis and the second vehicle axle, the first and second pairs of air springs being pneumatically equalised; and
e) a first pivoting structure guiding assembly for preventing lateral loads from being transferred to the first pair of air springs, the first pivoting structure guiding assembly comprising:
i) a first guide element mounted beneath the vehicle chassis and extending proximate the first lateral surface so as to block lateral movement thereof in the first lateral direction; and
ii) a second guide element mounted beneath the vehicle chassis and extending proximate the second lateral surface so as to block lateral movement thereof in the second lateral direction.

14. The tandem suspension of claim 13, wherein the second pivoting structure further comprises a third lateral surface facing in the first lateral direction and a fourth lateral surface facing in the second lateral direction, the tandem suspension further comprising a second pivoting structure guiding assembly for preventing lateral loads from being transferred to the second pair of air springs, the second pivoting structure guiding assembly comprising:
a) a third guide element mounted beneath the vehicle chassis and extending proximate the third lateral surface so as to block lateral movement thereof in the first lateral direction;
b) a fourth guide element mounted beneath the vehicle chassis and extending proximate the fourth lateral surface so as to block lateral movement thereof in the second lateral direction.

15. The tandem suspension of claim 13, wherein the first and second vehicle axles are steerable axles.

16. The tandem suspension of claim 13, wherein the trailing arms each have a unitary construction.
